(19) United States
(12) Patent Application Publication
(10) Pub. No.: US 2002/0195808 A1
(43) Pub. Date: Dec. 26, 2002

(54) Airbag having reinforced seams

(76) Inventors: Joseph J. Chiou, Clemmons, NC (US); Earl T. Crouch, Greensboro, NC (US)

Correspondence Address: JENKINS & WILSON, PA, 3100 TOWER BLVD, SUITE 1400, DURHAM, NC, 27707, US

(21) Appl. No.: 09/875,582

(22) Filed: Jun. 6, 2001

(51) Int. Cl. B60R 21/16

(52) U.S. Cl. 280/743.1

(57) ABSTRACT

An airbag made of a flexible fabric having an airbag seam sewn by stitching. The fabric defines an airbag inside and an airbag outside and a seam area, where the airbag inside has applied on it in the seam area a sealant.

### TECHNICAL FILED

The present invention relates in general to airbags, which are used as safety restraints in automobiles and other vehicles, and more particularly to reinforcement of the sewn seams of the airbags.

Abbreviations

| | |
|---|---|
| C | Centigrade |
| cm | centimeter |
| F | Fahrenheit |
| GE | General Electric |
| kg | kilogram |
| kgf/cm | kilograms of force per centimeter |
| mm | millimeter |
| Ph | phenyl moiety |
| lbf/in | pounds of force per inch |
| RTV | room temperature vulcanization |
| SLE | silicone liquid elastomer |

### BACKGROUND OF THE INVENTION

In the last decade or so, the use of front airbags as safety restraints in automobiles has become not only prevalent but also standard equipment on all automobiles. Front airbags employed in restraint systems in automobiles and other vehicles must comply with several requirements set by the United States Government.

For instance, front airbags must have the ability to inflate fully in milliseconds in order to absorb the impact of the passenger, yet also must have the ability to deflate quickly in order to provide pneumatic dampening. The essentially instantaneous deflation of the front airbag prevents the passenger from being propelled in the same direction as the direction of inflation of the front airbag.

Furthermore, the airbag fabric must be sufficiently low in air permeability so that when the inflation gas is released in order to inflate the airbag, the inflation gas does not penetrate the fabric and blow into the face of the passenger. Accordingly, fabrics employed in airbag construction should have characteristics of being lightweight but strong, relatively airtight, packable or foldable into a confined area, and resistant to abrasion. Also, as is well known in the art of airbag construction, the seams of airbags are sewn shut by stitching. Consequently, important characteristics for airbags include low air permeability, low weight, low thickness, and high strength for the fabrics, and also, high strength for the stitched sewn seams.

Nowadays, airbags are made from woven material that is polymeric, typically nylon, or sometimes polyester is used. Often, the airbag material is coated with either neoprene rubber or silicon rubber.

More recently, in addition to the use of airbags in the front of an automobile, the use of airbags in the side of an automobile has become increasingly prevalent. A side airbag is typically placed to the side of an automobile passenger, for instance inside a door or a seat or the like. Some examples of side airbags are shown in U.S. Pat. No. 5,765,863 issued in 1998 to Storey et al. (assignors to Morton International, Inc.) and U.S. Pat. No. 5,797,621 issued in 1998 to Ono (assignor to Kansei Corporation).

When an automobile receives an impact force due to a side impact collision or the like, the side airbag expands between the inner side of the automobile door and the passenger. The force of the potential impact to the passenger is substantially absorbed by the expansion of the side airbag, thus protecting the passenger.

As noted above, airbags quickly deflate to provide dampening. A particular kind of side airbag is the “head” side airbag, also known as the curtain airbag. When the curtain airbag deflates, the passenger could hit his/her head on the side of the automobile door, which, as is well known for the construction of curtain airbags, is ameliorated by having chambers from the stitches of the sewn seams in the airbag going in various snaking or S-shapes. The automobile industry is aiming toward a 6 second time as desirable for the inflation to remain until the deflation starts for curtain airbags so that they also provide rollover protection. However, the various S-shapes of the sewn seams in curtain airbags result in the inflation forces from the inflation gas being higher along certain portions of the sewn seams as compared to other portions of the sewn seams.

With the 6 second time until deflation, a particular problem arises with curtain airbags in that the higher forces along certain portions of the sewn seams can cause them to leak. Hence, not only can leaking inflation gas blow onto the passenger, but also leaking inflation gas results in too fast a deflation. The result of too fast a deflation is that the curtain airbag is incapable of staying inflated for a sufficiently long time (i.e., preferably 6 seconds) to provide rollover protection. Therefore, besides that curtain airbags and their fabrics should have the important characteristics mentioned above with respect to front airbags and their fabrics, another important characteristic, particularly for side airbags, (for instance, curtain airbags), is low air permeability for any stitched sewn seams that an airbag has.

Accordingly, a need has arisen in the art to find a way to reinforce the sewn seams in order to make these seams even stronger to help prevent leaking of airbags, particularly during the 6 second time for maintaining inflation until the onset of deflation for side airbags, especially curtain airbags.

Unexpectedly, the present inventor has discovered that application of a sealant, particularly a silicone sealant, to the seam area of airbag material, followed by stitching the seams to sew the airbags shut, results in greatly reinforced airbag seams. The sealant should be one that adheres to, but does not dissolve, the polymeric airbag fabric, nor the coating on the fabric, i.e., the SLE coating.

The disclosures of all patents mentioned here are incorporated by reference.

### SUMMARY AND OBJECTS OF THE INVENTION

Therefore, the present invention provides an airbag comprising a flexible fabric having an airbag seam sewn by stitching and defining an airbag inside and an airbag outside and a seam area, where the airbag inside has applied on it in the seam area a sealant. Consequently, the sewn seam is reinforced.

In a preferred embodiment, the present invention provides an airbag comprising a flexible fabric (a) having an airbag seam sewn by stitching and (b) defining an airbag inside and an airbag outside and a seam area. The airbag inside has applied on it in the seam area a sealant, whereby the sewn seam is reinforced. The flexible fabric is nylon polymer that includes, on the airbag inside, a coating of silicone liquid elastomer. An application of a layer of silicone sealant is on the silicone liquid elastomer in the seam area. The sealant layer has a thickness ranging from about 0.254 mm to about 1.27 mm and a width ranging from about 1 mm to about 30 mm. Also, the sealant layer has been cured for about 1 to about 60 minutes from about 100 to about 250° C. and provides to the seam area a peel strength of at least about 5 kgf/cm.

The present invention also provides a method for reinforcing a sewn seam of an airbag comprising a flexible fabric (a) having an airbag seam sewn by stitching and (b) defining a seam area, a first side that is an airbag inside, and a second side that is an airbag outside. The method comprises: (i) providing a flexible fabric; (ii) applying a sealant on the first side in the seam area; (iii) sewing the seam area by stitching a seam; and (iv) achieving an airbag having a reinforced sewn seam.

In a preferred embodiment, the present invention provides a method for reinforcing a sewn seam of an airbag to prevent leaking of inflation gas when the airbag is inflated, wherein the airbag comprises a flexible fabric (a) having an airbag seam sewn by stitching and (b) defining a seam area, a first side that is an airbag inside, and a second side that is an airbag outside. The preferred method comprises: (i) providing a flexible fabric, wherein the flexible fabric is nylon polymer that includes, on the first side, a coating of silicone liquid elastomer; (ii) applying a layer of silicone sealant on a portion of the first side in the seam area, wherein the sealant layer is on the silicone liquid elastomer coating in the seam area and wherein the sealant layer has a thickness ranging from about 0.254 mm to about 1.27 mm and a width ranging from about 1 mm to about 30 mm; (iii) placing another portion of the first side in the seam area so that the silicone liquid elastomer coating of the other portion is in contact with the sealant layer; (iv) curing the sealant layer for about 1 to about 60 minutes from about 100 to about 250° C. whereby the sealant layer provides to the seam area a peel strength of at least about 5 kgf/cm; (v) sewing the seam area by stitching a seam; (vi) inflating the airbag with inflation gas; and (vii) achieving an inflated airbag free of leaking of the inflation gas from the airbag inside via the seam area to the airbag outside for at least 6 seconds.

Accordingly, it is an object of the present invention to provide airbags with reinforced stitched seams due to the application of a sealant on the airbag fabric prior to sewing the airbag seams by stitching them shut.

It is an advantage of the present invention that the inventive airbags are particularly suited for side airbags (more particularly, curtain airbags, the sewn seams of which have various S-shapes) in automobiles and other vehicles as the inventive airbags ameliorate the problem of the sewn seams leaking, especially during the 6 second time until deflation of side airbags, as compared to ordinary side airbags that have the seams sewn but the seam area is absent any sealant or has weak sealant.

It is another advantage of the present invention in a preferred embodiment that the inflated airbag is free of leaking of the inflation gas from the airbag inside via the seam area to the airbag outside for at least 6 seconds. Thus, the preferred embodiment provides rollover protection.

Some of the objects of the invention having been stated, other objects, as well as other advantages, will become evident as the description proceeds in connection with the Laboratory Examples below.

### DETAILED DESCRIPTION OF THE INVENTION

By describing the stitched sewn seam of the inventive airbag as being reinforced is meant that the seam should have an improvement in low air permeability, reflected by the peel strength as measured by the modified Test Method 43 of ASTM D 751-89, as described in more detail below.

The flexible fabric of the inventive airbag should be a polymer, such as nylon or polyester.

Useful nylons and polymeric esters have valuable properties, including that of being capable of being formed into useful filaments, fibers and the like, and should also have high melting points and a low degree of solubility in organic solvents.

The polyesters are preferably high-melting, difficultly soluble, usually micro-crystalline, cold-drawing and linear, and may be highly polymerized esters of (a) terephthalic acid and (b) glycols of the series HO(CH₂)ₙOH, where n is an integer within the range of 2 to 10. Such polyesters can be obtained from polymethylene glycols having from 2 to 10 methylene groups, i.e., from ethylene glycol, trimethylene glycol, tetramethylene glycol, pentamethylene glycol, hexamethylene glycol, heptamethylene glycol, octamethylene glycol, nonamethylene glycol and decamethylene glycol. It is advantageous to use glycols having from 2 to 4 methylene groups, since these give highly polymerized esters with very high melting points, and of these glycols, ethylene glycol, HO(CH₂)₂OH, is preferred on the grounds of cost and availability. Mixtures of the glycols may be used if desired.

Examples of polyesters include, but are not limited to, highly polymeric polymethylene terephthalates; they are linear in structure with recurring structural units of the general formula

—O(CH₂)ₙOOC—Ph—CO—

where n is an integer within the range from 2 to 10.

For the preferred flexible fabric of the inventive airbag, nylon polymers (i.e., polyamides) may be advantageously employed. By nylon polymer it is intended to include copolymers and terpolymers thereof. Suitable nylon polymers are nylons which can be produced as polymers of the reaction products of (i.e., polycondensation products and/or polyaddition products of) various combinations of diacids and diamines or lactams as well as copolymers, terpolymers, et cetera, combinations of lactams, diacids and diamines with lactams, multiple diacids and dibases with lactams, et cetera.

It is intended to include, but not limit to, the several such nylons given below. Polymers of the reaction products of diacids and dibases include the polymer of the reaction product of adipic acid and hexamethylene diamine (commonly known as nylon 6,6), the polymer of the reaction product of sebacic acid and hexamethylene diamine (commonly known as nylon 6,10), and polymers of the reaction product of hexamethylenediamine and a 12-carbon dibasic acid (commonly known as nylon 6,12). Polymers of the reaction product of lactams include, but are not limited to caprolactam (commonly known as nylon 6), the polycondensation product of the monomer 11-aminoundecanoic acid (commonly known as nylon 11), and the addition product of lauryllactam or cyclo-decalactam (both of which are commonly known as nylon 12). These and similar lactam copolymers are available with a wide variety of caprolactam and lauryllactam relative amounts. Other commercially available nylons include copolymers made from caprolactam with adipic acid and hexamethylene diamine (commonly known as nylon 666) and terpolymers made from caprolactam and lauryllactam with adipic acid and hexamethylene diamine (commonly known as nylon 66612). It is further possible to blend physically and to extrude various nylons to achieve a wide range of physical properties.

A very suitable nylon polymer is nylon 11, nylon 12, a copolymer of nylon 11, a terpolymer of nylon 11, a terpolymer of nylon 11, a copolymer of nylon 12, a terpolymer of nylon 12, or mixtures thereof. Commercially available nylon 11 or nylon 12 include, but are not limited to, Nuodex (™) nylon 12 from Huls, Rilsan (™) nylon 11 from Atochem, and Grilamid (™) nylon 12 from Emser. The nylon 11 or 12 may contain a minor amount, such as about 5% to 25% by weight, of a nylon 6,12.

In an especially preferred embodiment, a very suitable nylon for use in the present invention is nylon 6,6 which may be purchased from DuPont or Solutia.

As is well known in the airbag art, the flexible fabric from which airbags are made may be coated with various materials, such as neoprene rubber or silicone rubber. The coating material may be applied with various apparatus as is well known in the art, for instance with a knife roll over coating apparatus, an extrusion coating apparatus, a laminating apparatus, and the like. Coating materials employed with airbags are typically silicone liquid elastomers (i.e., a kind of silicone rubber), such as for the coated airbags described in U.S. Pat. No. 5,658,674 issued in 1997 to Lorenzetti et al.

The flexible fabric (either coated or not coated with SLE or other coating material) is given an application of silicone sealant in the seam area prior to stitching the seams. The sealant is applied on the side of the fabric that will become the airbag inside for a finished airbag. For fabric coated with SLE or other coating, the coated side is what becomes the airbag inside for a finished airbag, and thus, the sealant is applied to the coated side. For the inventive airbag, the preferred sealant to be applied to the inside of the airbag in the seam area is a silicone sealant. As described in more detail below, such silicone sealants may be purchased from General Electric, General Electric/Toshiba, or Shin-Etsu.

A suitable thickness for a layer of sealant ranges from about 10 mils (about 0.254 mm) to about 50 mils (about 1.27 mm), more preferably about 20 mils (about 0.508 mm) to about 40 mils (about 1.016 mm), even more preferably about 25 mils (about 0.635 mm) to about 35 mils (about 0.889 mm), and most preferably about 30 mils (about 0.762 mm). A suitable width for a layer of sealant ranges from about 1 mm to about 30 mm, more preferably about 2 mm to about 20 mm, even more preferably 5 mm to about 15 mm, and most preferably about 10 mm. The layer of sealant, particularly when it is silicone, preferably is cured with heat, such as for about 1 to about 60 minutes from about 100 to about 250° C., more particularly, for about 3 to about 50 minutes from about 150 to about 200° C.

The seal strength of flexible fabric having an application of sealant as set out below was tested substantially in accordance with the peel strength adhesion test method recited in Test Method 43 of ASTM D 751-89. The difference was that for the modified Test Method 43 of ASTM D 751-89 employed in the present invention, the longitudinal strips of fabric were peeled apart in the transverse direction, which would correspond to the longitudinal direction of gas flow during airbag inflation, namely the direction from the sewn seam to the airbag edge in a finished airbag. A suitable peel strength provided by the layer of sealant, particularly silicone sealant, to the seam area is at least about 5 kgf/cm, and may be at least about 11 kgf/cm, or even higher. A peel strength under 0.5 kgf/cm would likely be undesirable as the sealant would be weak.

### LABORATORY EXAMPLES

Nylon 6,6 yarn was purchased from DuPont and Solutia and the yarn was woven into fabric. As described in U.S. Pat. No. 5,863,625 to Chiou, assignor to Highland, the fabric was coated with SLE (silicone liquid elastomer) coating on one side, using a knife roll over coating apparatus.

Next, the SLE coated nylon 6,6 fabric was cut to form 10 substrate samples.

Sealant was applied by squeezing sealant out of a tube container through the tube nozzle onto the SLE coated side of a substrate sample and by using a template to form a 30 mil (about 0.762 mm) thick layer of sealant coating, which was about 10 mm in width. Specifically for the silicone sealant 1326-03-082 (A) and (B) from GE, which is in accordance with U.S. Pat. No. 5,998,515, this sealant comes in 2 tubes, for part (A) and part (B), that are attached to a holder apparatus that has a mixing tube with a helix inside. The apparatus is used to squeeze and dispense (A) and (B) into the mixing tube, and so (A) and (B) are mixed together by the helix, so that the mixture comes out the exit end of the mixing tube.

Then, the resultant sealant coated substrate sample was sandwiched with a sealant-free substrate sample by placing the SLE side of the sealant-free substrate sample onto the 30 mil (about 0.762 mm) layer of sealant coating. The sandwich of substrate/sealant/substrate was cut to form a sandwich strip of about 1 inch (about 25 mm) in width for a peeling test substantially in accordance with Test Method 43 of ASTM D 751-89, as noted above.

This was repeated 4 more times, each time with a different container of sealant, to form a total of 5 sandwich strips of substrate/sealant/substrate.

Each of the 5 different sealants of the 5 different sandwich strips was as set out below in Table A.

TABLE A

| | TRADE NAME | |
|---|---|---|
| SANDWICH | OF SEALANT | MANUFACTURER OF SEALANT |
| (1) | GE 1326-93-082 | silicone sealant purchased from |
| | (A) and (B) | General Electric |
| (2) | GE RTV 6445 | silicone sealant purchased from |
| | | General Electric |
| (3) | Brand A RTV 1 | silicone sealant purchased from |
| | | Shin-Etsu |
| (4) | Brand A RTV 2 | silicone sealant purchased from |
| | | Shin-Etsu |
| (5) | Brand B RTV 1 | silicone sealant purchased from |
| | | General Electric/Toshiba |

Next, each of the 5 sandwich strips was cured for about 3 minutes, some at room temperature (RT) and some at 350° F. (176.7° C.) in an oven sold by General Signal under the trade name Blue M oven. Then, each cured sandwich was evaluated for peel adhesion substantially in accordance with ASTM D 751-89, Test method 43, as noted above. The results in pounds of force per inch (Ibf/in), also converted into kilograms of force per centimeter (kgf/cm), were as set out below in Table B.

TABLE B

| SANDWICH | OVEN OR RT | lbf/in | kgf/cm |
|---|---|---|---|
| (1) | OVEN | 60.6 | 10.8 |
| (2) | OVEN | 38.2 | 6.82 |
| (3) | RT | 34.7 | 6.20 |
| (4) | RT | 30.8 | 5.50 |
| (5) | RT | 31.6 | 5.64 |

As can be seen, the best results occurred for sandwich 1, which was made with sealant GE 1326-03-082 (A) and (B), and then cured with heat in an oven.

For a finished airbag, the sealant would be applied in the seal area, prior to and in addition to stitching closed the seam to seal the airbag. Thus, the above-described peel test was done in the transverse direction, which in a sewn shut bag (i.e., stitched closed), would be in the longitudinal direction of gas flow during inflation from the stitching of the seam to the airbag edge.

It will be understood that various details of the invention may be changed without departing from the scope of the invention. Furthermore, the foregoing description is for the purpose of illustration only, and not for the purpose of limitation--the invention being defined by the claims.

What is claimed is:

1. An airbag comprising a flexible fabric (a) having an airbag seam sewn by stitching and (b) defining an airbag inside and an airbag outside and a seam area, where the airbag inside has applied on it in the seam area a sealant, whereby the sewn seam is reinforced.

2. The airbag of claim 1, wherein the flexible fabric comprises a polymer selected from the group consisting of nylon polymer and polyester polymer.

3. The airbag of claim 2, wherein the flexible fabric comprises nylon polymer.

4. The airbag of claim 3, wherein the nylon polymer is selected from the group consisting of nylon 6,6; nylon 6,10; nylon 6,12; nylon 6; nylon 11; nylon 12; nylon 666; nylon 66612; and combinations thereof.

5. The airbag of claim 2, wherein the flexible fabric comprises polyester polymer.

6. The airbag of claim 5, wherein the polyester polymer is selected from highly polymerized esters of (a) terephthalic acid and (b) glycols of the series HO(CH₂)ₙOH, where n is an integer within the range of 2 to 10.

7. The airbag of claim 1, wherein the flexible fabric includes on the airbag inside a coating material.

8. The airbag of claim 7, wherein the coating material is selected from the group consisting of neoprene rubber and silicone rubber.

9. The airbag of claim 8, wherein the silicone rubber is silicone liquid elastomer.

10. The airbag of claim 7, wherein on the airbag inside, an application of a layer of sealant is on the coated side of the fabric in the seam area.

11. The airbag of claim 10, wherein the sealant layer comprises silicone sealant.

12. The airbag of claim 10, wherein the sealant layer has a thickness ranging from about 0.254 mm to about 1.27 mm.

13. The airbag of claim 10, wherein the sealant layer has a width ranging from about 1 mm to about 30 mm.

14. The airbag of claim 10, wherein the sealant layer provides to the seam area a peel strength of at least about 5 kgf/cm.

15. The airbag of claim 10, wherein the sealant layer has been cured for about 1 to about 60 minutes from about 100 to about 250° C.

16. The airbag of claim 1, wherein the airbag is a side airbag.

17. The airbag of claim 16, wherein the side airbag is a curtain airbag.

18. An airbag comprising a flexible fabric (a) having an airbag seam sewn by stitching and (b) defining an airbag inside and an airbag outside and a seam area, where the airbag inside has applied on it in the seam area a sealant, whereby the sewn seam is reinforced, wherein:
(i) the flexible fabric is nylon polymer that includes, on the airbag inside, a coating of silicone liquid elastomer; and
(ii) an application of a layer of silicone sealant is on the silicone liquid elastomer in the seam area, wherein the sealant layer has a thickness ranging from about 0.254 mm to about 1.27 mm and a width ranging from about 1 mm to about 30 mm, the sealant layer having been cured for about 1 to about 60 minutes from about 100 to about 250° C. and providing to the seam area a peel strength of at least about 5 kgf/cm.

19. The airbag of claim 16, wherein the airbag is a side airbag.

20. The airbag of claim 19, wherein the side airbag is a curtain airbag.

21. A method for reinforcing a sewn seam of an airbag, wherein the airbag comprises a flexible fabric (a) having an airbag seam sewn by stitching and (b) defining a seam area, a first side that is an airbag inside, and a second side that is an airbag outside, said method comprising:
(i) providing a flexible fabric;
(ii) applying a sealant on the first side in the seam area;
(iii) sewing the seam area by stitching a seam; and
(iv) achieving an airbag having a reinforced sewn seam.

22. The method of claim 21, wherein the flexible fabric comprises a polymer selected from the group consisting of nylon polymer and polyester polymer.

23. The method of claim 22, wherein the flexible fabric comprises nylon polymer.

24. The method of claim 23, wherein the nylon polymer is selected from the group consisting of nylon 6,6; nylon 6,10; nylon 6,12; nylon 6; nylon 11; nylon 12; nylon 666; nylon 66612; and combinations thereof.

25. The method of claim 22, wherein the flexible fabric comprises polyester polymer.

26. The method of claim 25, wherein the polyester polymer is selected from highly polymerized esters of (a) terephthalic acid and (b) glycols of the series HO(CH₂)ₙOH, where n is an integer within the range of 2 to 10.

27. The method of claim 21, wherein the flexible fabric includes on the airbag inside a coating material.

28. The method of claim 27, wherein the coating material is selected from the group consisting of neoprene rubber and silicone rubber.

29. The method of claim 28, wherein the silicone rubber is silicone liquid elastomer.

30. The method of claim 27, wherein on the airbag inside, an application of a layer of sealant is on the coated side of the fabric in the seam area.

31. The method of claim 30, wherein the sealant layer comprises silicone sealant.

32. The method of claim 30, wherein the sealant layer has a thickness ranging from about 0.254 mm to about 1.27 mm.

33. The method of claim 30, wherein the sealant layer has a width ranging from about 1 mm to about 30 mm.

34. The method of claim 30, wherein the sealant layer provides to the seam area a peel strength of at least about 5 kgf/cm.

35. The method of claim 30, wherein the sealant layer has been cured for about 1 to about 60 minutes from about 100 to about 250° C.

36. The method of claim 21, wherein the airbag is a side airbag.

37. The method of claim 36, wherein the side airbag is a curtain airbag.

38. A method for reinforcing a sewn seam of an airbag to prevent leaking of inflation gas when the airbag is inflated, wherein the airbag comprises a flexible fabric (a) having an airbag seam sewn by stitching and (b) defining a seam area, a first side that is an airbag inside, and a second side that is an airbag outside, said method comprising:
(i) providing a flexible fabric, wherein the flexible fabric is nylon polymer that includes, on the first side, a coating of silicone liquid elastomer;
(ii) applying a layer of silicone sealant on a portion of the first side in the seam area, wherein the sealant layer is on the silicone liquid elastomer coating in the seam area and wherein the sealant layer has a thickness ranging from about 0.254 mm to about 1.27 mm and a width ranging from about 1 mm to about 30 mm;
(iii) placing another portion of the first side in the seam area so that the silicone liquid elastomer coating of the other portion is in contact with the sealant layer;
(iv) curing the sealant layer for about 1 to about 60 minutes from about 100 to about 250° C. whereby the sealant layer provides to the seam area a peel strength of at least about 5 kgf/cm;
(v) sewing the seam area by stitching a seam;
(vi) inflating the airbag with inflation gas; and
(vii) achieving an inflated airbag free of leaking of the inflation gas from the airbag inside via the seam area to the airbag outside for at least 6 seconds.

39. The method of claim 38, wherein the airbag is a side airbag.

40. The method of claim 39, wherein the side airbag is a curtain airbag.
